(19) United States
(12) Patent Application Publication
(10) Pub. No.: US 2026/0118560 A1
(43) Pub. Date: Apr. 30, 2026

(54) OPTICAL FILTER WITH IMPROVED VIEWING ANGLE CHARACTERISTICS

(71) Applicant: ALPHAMICRON INCORPORATED, Kent, OH (US)

(72) Inventors: Tamas Kosa, Hudson, OH (US); Bahman Taheri, Shaker Heights, OH (US)

(73) Assignee: ALPHAMICRON INCORPORATED, Kent, OH (US)

(21) Appl. No.: 19/165,039

(22) PCT Filed: Mar. 13, 2024
(86) PCT No.: PCT/US2024/019620

§ 371 Date: Sep. 12, 2025

Related U.S. Application Data
(60) Provisional application No. 63/451,647, filed on Mar. 13, 2023.

(51) Int. Cl. G02B 5/00; G02B 5/22; G02B 5/30; G02F 1/00; G02F 1/137

(52) U.S. Cl. CPC G02B 5/003; G02B 5/223; G02B 5/3016; G02B 5/3083; G02F 1/0063; G02F 1/13706; G02F 1/13725; G02F 2203/01; G02F 2203/055

(57) ABSTRACT

A light absorbing filter includes a chiral anisotropic liquid crystal host having a positive anisotropy and a dichroic light absorbing moiety in association with the host. The filter is characterized by an absorbance A_{q} for light measured at incident angle q from normal to the filter surface, that is at least 1% higher or at least 1% lower than an absorbance A_{T} predicted by Beer's law when θ is at least 30°. The light absorbing filter may be used in association with an optical element and a light source.

### CROSS-REFERENCE TO RELATED APPLICATIONS

This application claims priority to, and any other benefit of, U.S. Provisional Patent Application Ser. No. 63/451,647, entitled OPTICAL FILTER WITH IMPROVED VIEWING ANGLE CHARACTERISTICS, filed Mar. 13, 2023, the entire disclosure of which is fully incorporated herein by reference.

### TECHNICAL FIELD

The present disclosure relates to optical filters, particularly to optical filters having reduced vignetting properties or controllable vignetting properties.

### BACKGROUND

Optical filters are widely used in numerous optical systems to control the amount of light from a light source that is received by the eye, a sensor, or other photosensitive element. For example, persons may wear tinted sunglasses to reduce the amount of light from the general environment reaching their eyes. A photographer may place a filter over a camera lens. Many conventional optical filters are light-absorbing filters that include some kind of light-absorbing material (typically organic or inorganic dyes or pigments). The light-absorbing material may be distributed within a polymer film or a glass, or alternatively distributed in a fluid or gel contained between clear plates or films. Such filters may act as neutral density filters or color filters. Some optical filters are passive filters, i.e., having a relatively fixed set of properties upon manufacture. Active filters are also known where the optical properties, e.g., the light transmittance, can be altered based on some stimulation such as application of a voltage, current, heat, UV radiation, or the like. In some non-limiting examples, an active optical filter may be based on electrochromic technology, liquid crystal technology, photochromic technology, or the like.

The amount of light absorbed by a light-absorbing filter generally follows the well-known Beer's law: A=ϵ l C, where A=absorbance, ϵ=absorption coefficient, C=concentration of light-absorbing material, and l=optical path length. FIG. 1 is a cross-sectional schematic of a light-absorbing filter of the prior art. Light 126a, 126b, and 126c from a light source, e.g., a scene that is being photographed, passes through optical filter 101 to produce attenuated light 126a′, 126b′, and 126c′ that is received by an optical sensor 140 (which may be a camera, a person's eye, or other radiation-sensitive device). Light 126b is normal to the surface of the optical filter whereas light 126a and 126c impinge at angle θ₁ relative to normal. Since the refractive index of the light-absorbing filter is higher than air (e.g., the index of refraction of glass is 1.52 whereas air is ˜1), the light within the filter will traverse at an angle θ₂, as described by Snell's law. The optical path lengths for light 126a and 126c passing through the filter (optical path lengths 130a and 130c, respectively) will be longer than the optical path length for light 126b (optical path length 130b). The consequence of the longer path length is that there is more absorbance of light 126a and 126c than of light 126b. To the optical sensor 140, the scene will appear darker near the edge of the optical filter relative to its center. This phenomenon leads to “vignetting”. There are numerous other optical effects that may contribute to vignetting and Beer's law is just one contributor. The vignetting effect may be acceptable for many applications, but can become undesirable in some situations that use or require high viewing angles, e.g., as may occur with wide-angle lenses or panoramic type images.

Thus, there is a need for optical filters that may attenuate light in a manner with reduced vignetting.

### SUMMARY

In accordance with some embodiments, a light absorbing filter is disposed in association with an optical element and a light source. The light absorbing filter includes a chiral anisotropic liquid crystal host having a positive anisotropy and a dichroic light absorbing moiety in association with the host. The filter is characterized by an absorbance A_{θ} for light measured at incident angle θ from normal to the filter surface, that is at least 1% higher or at least 1% lower than an absorbance A_{T} predicted by Beer's law when θ is at least 30°. The light absorbing filter may be used in association with an optical element and a light source.

In accordance with some other embodiments, the light absorbing filter includes a chiral anisotropic liquid crystal host having a dichroic light absorbing moiety in association with the host, wherein the filter is characterized by equation (1):

$$OM = log [ ( D ( λ ) - 1 ) * ( \vert Δ n \vert * p ) / λ ] \qquad ( 1 )$$

In equation (1), OM=the vignetting optical metric, wherein OM is in a range of −1.3 to 3.0, D(λ)=the dichroic ratio of the light absorbing moiety at the wavelength λ, |Δn|=the birefringence of the liquid crystal host, p=the pitch of the liquid crystal host (μm), and λ=the wavelength of light absorbed by the light absorbing moiety (μm).

The present disclosure provides light absorbing filters that may have one or more of at least the following advantages relative to conventional light absorbing filters: reduced vignetting; controllable or adjustable vignetting; more uniform appearance at angles other than normal to the filter; better viewing angle performance, or improved compatibility with wide-angle lenses. In some cases, the present light absorbing filters may be used with a camera lens system for capturing light-filtered images having reduced vignetting.

### BRIEF DESCRIPTION OF DRAWINGS

FIG. 1 is a cross-sectional schematic of a prior art optical filter.

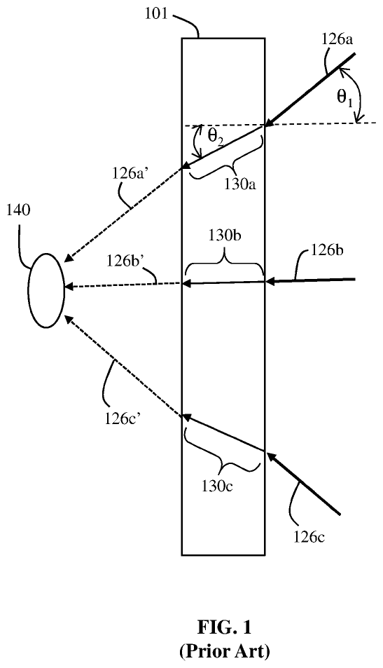

FIGS. 2A (camera image) and 2B (graph) illustrate the vignetting performance of a prior art optical filter in combination with a wide-angle lens as a function of angle.

FIGS. 3A (camera image) and 3B (graph) illustrate the vignetting performance of an example optical filter in combination with a wide-angle lens as a function of angle.

FIG. 4 is a cross-sectional view of a non-limiting example of an active optical filter according to some embodiments.

### DETAILED DESCRIPTION

It should be understood that embodiments include a variety of aspects, which may be combined in different ways. The following descriptions are provided to list elements and describe some of the embodiments of the present application. These elements are listed with initial embodiments; however, it should be understood that they may be combined in any manner and in any number to create additional embodiments. The variously described examples and embodiments should not be construed to limit embodiments of the present application to only the explicitly described systems, techniques, and applications. It is to be understood that the drawings are for purposes of illustrating the concepts of the disclosure and may not be to scale.

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.”

As used herein, a phrase that recites a range of values is inclusive of the end values, for example, “between X and Y,” “range of X to Y,” “from X to Y,” includes X and Y, or the phrase “up to Y” includes Y.

As used in the specification and in the claims, the terms “comprise(s),” “include(s),” “having,” “has,” “can,” “contain(s),” and variants thereof, as used herein, are intended to be open-ended transitional phrases, terms, or words that require the presence of the named ingredients, components, or steps, and that permit the presence of other ingredients, components, or steps.

The present disclosure may include one or more of the following terms whose meanings may be as described below.

### Definitions

“Absorption” as used herein may define the percentage of light absorbed by the guest-host mixture, cell, optical device, or the like.

“Absorption band” may define the spectral wavelength wherein absorption occurs.

“Clear state” or “clear state transmission”, as used herein, may refer to the state where an active optical filter exhibits maximal or relatively high light transmittance.

“Dark state” or “dark state transmission” may refer to the state where an active optical filter exhibits minimal or relatively low light transmittance.

A “Dichroic (DC) Dye” is dye molecule that may have a rodlike shape and displays a unique anisotropy in its light absorption properties parallel (al) and perpendicular (al) to the molecule, this being characterized by the dichroic ratio, DR=α_{∥}/α_{⊥}. Any molecule having a dichroic ratio (DR) that deviates from unity is one that exhibits “dichroism”.

“Dichroic ratio”, “average dichroic ratio”, D(λ), or Dₘᵢₓ of the mixture refers to the dichroic ratio of the guest-host mixture which may contain one or more DC dyes. D(λ) is the dichroic ratio measured at wavelength λ, typically in the visible region of 400-700 nm. The mixture dichroic ratio may be measured using the formula for Effective Dichroic Ratio (D_{eff}) or Aggregate Effective Dichroic Ratio (D_{eff-agg}). Thus, as used herein, D(λ), Dₘᵢₓ, D_{eff} or D_{eff-agg} are used interchangeably (depending on which method is used to measure the dichroic ratio) and describe the same parameter.

“Narrow Band Absorption” as used herein, is defined as a spectral absorption band width with a Full Width at Half Max (FWHM) that is less than or equal to 175 nm, or alternatively less than or equal to 165 nm, 155 nm, 120 nm, or 80 nm, where the entire spectral absorption band is measured within the visible region of 400-700 nm.

“Narrow Band Mixture” refers to a guest-host liquid crystal mixture that can be used in a narrow band cell.

Nematic-isotropic transition temperature or T_{NI} is the temperature at which the liquid crystal undergoes the nematic to isotropic transition, which is the transition from the orientationally ordered nematic phase to the totally disordered isotropic phase. As used herein, T_{NI} refers to the nematic-isotropic transition temperature of the guest-host mixture.

“Order parameter of the guest-host mixture” or “Sₘᵢₓ” refers to the order parameter of the guest-host mixture. The mixture may contain one or more dyes as well as other dopants. The Sₘᵢₓ can be measured according to the method described herein, e.g. using the formula for Effective Order Parameter (S_{eff}) or Aggregate Effective Order Parameter (S_{eff-agg}). As used herein Sₘᵢₓ, S_{eff} and S_{eff-agg} are used interchangeably (depending on which method is used to measure the order parameter) and describe the same parameter.

“Polarization dependence” is a measure of a material's response to two orthogonal linear polarizations, i.e., where the optical properties of a material experienced by an incident light (such as index of refraction or absorption/transmittance) are dependent on the polarization of the incident light.

“Polarization sensitivity” is the relative measure of the difference of the material's response to first and second orthogonally polarized incident light. In ideal, theoretical limit, zero percent (0%) polarization sensitivity refers to a completely polarization insensitive device and a 100% polarization sensitivity refers to a completely polarization sensitive device as obtained using a polarizer.

“Polarizer” refers to a material, layer, or component that absorbs or reflects one polarization of incident light more than the orthogonal polarization.

“Transmission” and “Transmittance” are used interchangeably and mean the percentage of light that is transmitted through a mixture or device.

“Transmission swing” refers to the difference in transmission between the clear state and dark state transmissions. For example, if the clear state transmission is 65% and the dark state transmission is 15%, the transmission swing is 65−15=40%. The transmission swing of an optical device can be measured using equipment such as a “haze-gard plus” device from BYK-Gardner, USA, or equivalent.

“Uniform optical retardation” refers to plastic substrates having an optical retardation variation that is less than ±20% across the substrate for any given wavelength. “Optical retardation” is defined as the change in the optical phase experienced by different polarizations of incident light.

“Visible light” refers to a wavelength range of about 400 to about 700 nm.

“Wide band absorption” as used herein, may refer to a spectral absorption band that is greater than 175 nm, and preferably greater than 180 nm, 185 nm, 190 nm, 195 nm or 200 nm, where the entire spectral absorption band is contained within the range of visible wavelengths, typically assumed to be 400 nm-700 nm Wide band absorption may in some cases have a low color chromaticity, but in other cases, may have a color.

“Wide Band Mixture” refers to a guest-host liquid crystal mixture that can be used in a wide band cell.

The authors have worked extensively in the field of variable transmission optical devices, particularly those using liquid crystal guest-host (LC-GH) technology. Such technology has found commercial success in numerous applications, e.g., as electronically controllable, variable transmission goggles or windows. A large transmission swing is often a figure of merit valued by such applications. It has been found that higher transmission swing can be achieved by designing the LC-GH system to have relatively low polarization dependence. For example, material sets having low birefringence and/or that do not operate in the Mauguin limit have been preferred. In this case, the systems show vignetting similar to that expected in conventional absorptive systems. However, as described in the present application, it has been discovered that redesigning the LC-GH system can provide optical filters that surprisingly show significantly reduced vignetting, but they still retain effective light attenuation properties. Optical filters of the present application may be active or passive, as described below.

### Initial Tests

To test vignetting, an optical filter of interest was placed on a light table designed to shine light uniformly in all directions. A camera with a fisheye lens was placed directly on the filter and images were taken. Relative light intensity received was plotted as a function of angle off normal.

### Comparative

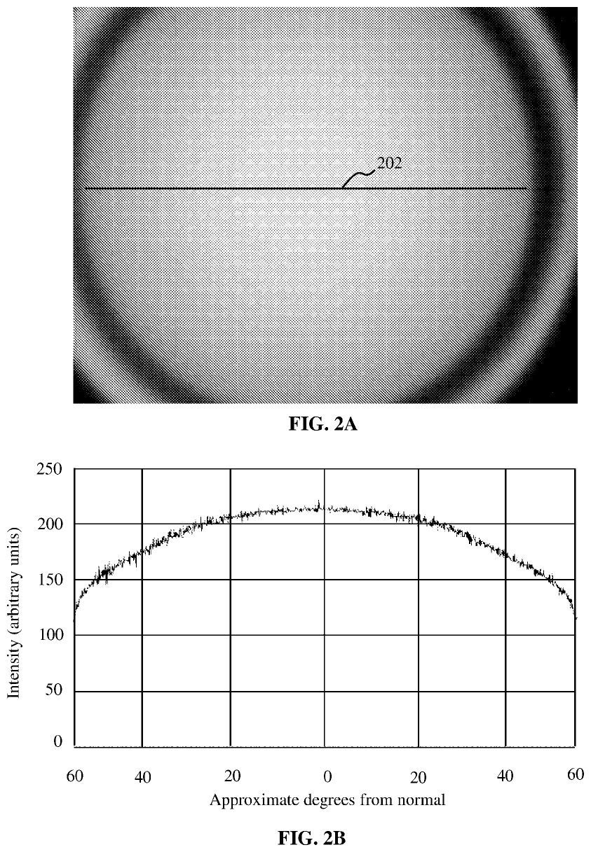

A commercial, light-absorbing glass neutral density filter (product #NE210B from ThorLabs) was tested having a rated optical density of 1.0, i.e., it allows 10% transmission of incident light normal to the filter (θ₁=0°). FIG. 2A is the camera image itself, and FIG. 2B is a graph showing the relative intensity (arbitrary units) as a function of angle off normal as measured approximately along line 202 that was superimposed on FIG. 2A. At normal light incidence (0°), the transmitted light intensity count is about 215. At 60° incidence in either direction, the transmitted light intensity count drops to about 120, i.e., about 44% lower. Even at 40° incidence the transmitted light count drops to about 175, i.e., about 19% lower. Thus, the vignetting is rather severe, but the performance is approximately as predicted by Beer's law (in combination with Snell's law).

### Example

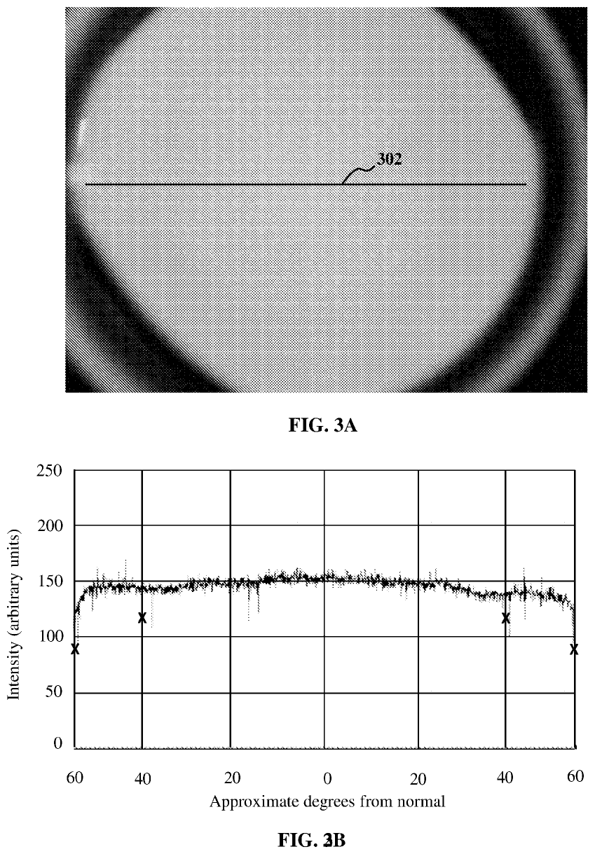

A passive LC-GH system was prepared using a set of dichroic dyes in a chiral liquid crystal host in a planar aligned cell. The dichroic dye in the LC host had a dichroic ratio of about 15. The liquid crystal host had a positive anisotropy, a birefringence of about 0.12, and a pitch of about 4 microns. The LC-GH material was provided between two transparent substrates and the combination of dyes produced a generally neutral density filter. The absolute % T or absorbance was not measured, but it was visibly darker than the comparative filter. The example filter was tested in a manner like that of the comparative filter. FIG. 3A is the camera image itself, and FIG. 3B is a graph showing the relative intensity (arbitrary units and not necessarily the same scale as in FIG. 2B in an absolute sense) as a function of angle off normal as measured approximately along line 302 that was superimposed on FIG. 3A. At normal light incidence (0°), the transmitted light intensity count is about 155. At 60° incidence, the transmitted light intensity count drops to about 120, i.e., only 23% lower. At 40° incidence the transmitted light count to between 145 and 140, i.e., only 6-10% lower. The curve of FIG. 3B is clearly much flatter than that of FIG. 2B. The “x” marks in FIG. 3B denote the expected intensity if the filter behaved as the conventional, comparative filter of FIG. 2A/2B. Not only does the example optical filter show less vignetting than the comparative, but there is no sacrifice of light attenuation performance. In fact, the example optical filter is both a stronger (more light absorbing) filter and a lower vignetting filter.

The example filter described above is just one embodiment. In some cases, rather than adding a small molecule type dichroic guest that aligns with the LC host material, the LC host material may include a covalently attached dichroic light absorbing moiety. In some cases, rather than using a fluid LC-GH mixture provided between two substrates, the LC-GH material may itself be a free-standing polymeric film. Rather than a neutral density filter, the reduced-vignetting optical filter may be designed to filter a particular color. For convenience, the sections below regarding LC-GH materials and properties are provided primarily in the context of active optical filters, but the skilled artisan will understand how the teachings can be generally applied to passive optical filters. In the case of active optical filters, most of the discussion is with respect to systems having reduced vignetting. In some embodiments, however, active optical filters may be designed to have variable vignetting. In some cases, such as for artistic effect or for providing reduced distraction at high viewing angles, higher vignetting may be desirable. An active optical filter may be designed that can alternate between different levels of vignetting, e.g., between a state of reduced vignetting and a state of higher vignetting (a dynamic or variable vignetting optical filter).

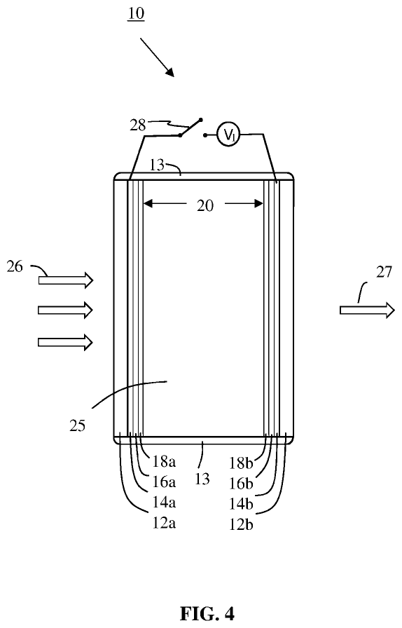

FIG. 4 is a cross-sectional view of a non-limiting example of an active optical filter according to some embodiments. Incident light 26 is at least partially absorbed by optical filter 10 which passes through as transmitted (attenuated) light 27. Although just one filter is shown, incident light may pass through two or more filters.

Optical filter 10 may include a pair of substrates, 12a, 12b. As discussed in more detail later, the substrates may be independently selected and include, for example, a polymeric material, a glass, or a ceramic. A pair of transparent conducting layers, 14a, 14b may be provided or coated over each respective substrate surface interior to the cell. In some embodiments, an optional passivation layer (which in some cases may be referred to as an insulating layer or “hard coat”), 16a, 16b, may be provided over the respective transparent conducting layer. The passivation layer may include, for example, a non-conductive oxide, sol-gel, polymer, or a composite. An optional alignment layer 18a, 18b, may be provided over the passivation layer or the transparent conducting layer. As a non-limiting example, the alignment layer may include polyimide. In some embodiments, the alignment layer may function as a passivation layer. In some embodiments, the alignment layer may be rubbed as is known in the art to assist in orienting the electro-optic material, e.g., a LC host, near the surface. In some embodiments, both alignment layers of a cell are rubbed. In some embodiments, a cell may include only one brushed alignment layer.

Optical filter 10 includes electro-optic material 25 provided between the substrates. In the case of an active optical filter, the electro-optic material may be capable of changing from a state of lower light transmittance to a state of higher light transmittance in a first wavelength region upon a change in an electric field applied across the electro-optic material. The electric field may be changed, for example, by changing the voltage applied between the pair of transparent conductive layers 14a, 14b. In some embodiments, the electro-optic material is an LC-GH material. As shown in FIG. 4, in some embodiments, the LC-GH material may be in its most light absorbing state (dark state) when no voltage is applied. In some cases, a reduced vignetting optical filter having a dark state at V=0 may in some cases be provided by using an LC host having positive anisotropy. Conversely, an LC host having negative anisotropy may be used to produce an optical filter that is relatively clear (high transmission) at V=0, but can produce relatively low vignetting optical filter when a voltage is applied to produce its dark state. In such cases, the application of an intermediate voltage results in vignetting between those observed at clear or dark states. In some cases, a dynamic or variable vignetting optical filter may have a multilayer structure including a first cell having a positive anisotropy LC host and a second cell having a negative anisotropy LC host.

The substrates and any overlying layers define a cell gap 20 (“d”). In some embodiments (not shown), the cell may include spacer beads or other structures to maintain the gap. In some cases, the cell structure may be enclosed by sealing material 13 such as a UV-cured optical adhesive or other sealants known in the art.

The conducting layers may be electrically connected to a variable voltage supply which are represented schematically by the encircled V₁. FIG. 4 shows the cell power circuit with its switch 28 open so that no voltage is applied and the optical filter is in its dark state. When switch 28 is closed, a variable voltage or electric field may be applied across liquid crystal guest-host material 25.

### Electro-Optic Material

An electro-optic material is one capable of changing its light absorption profile upon application of an electric field. In some embodiments, the electro-optic material may include a guest-host system having an LC host and a DC dye dissolved or dispersed therein, or alternatively a dichroic light absorbing moiety covalently attached to the LC host (all considered a guest-host mixture). Whether dissolved, dispersed, or attached, such a composition may be referred to as an LC-GH material or mixture.

In some embodiments, a liquid crystal guest-host includes a mixture of a cholesteric or chiral nematic liquid crystal host and a dyestuff material. The dyestuff material may be characterized as having dichroic properties, and as described below, may include a single dye or a mixture of dyes (DC light absorbing moieties) to provide these properties. In some embodiments, the liquid crystal guest-host mixture may be formulated as a “narrow band mixture” to produce a color filter or alternatively as a “wide band mixture” to produce a generally neutral density filter. Note that the term “mixture” in the context of guest-host materials is generally used broadly herein, and may refer to a DC moiety covalently attached to the LC host. A guest-host mixture may be, but is not necessarily, a simple combination of separate dye and liquid crystal molecules.

### LC Host

In some embodiments, the host includes a chiral nematic or cholesteric liquid crystal material (collectively “CLC”) which may have a negative dielectric anisotropy (“negative CLC”) or a positive dielectric anisotropy (“positive CLC”). In some cases, a positive CLC may be selected to provide reduced vignetting. In some cases, a negative CLC may be selected to provide increased vignetting. In some embodiments of the CLC, the liquid crystal material is cholesteric, or it includes a nematic liquid crystal in combination with a chiral dopant. A CLC material has a twisted or helical structure. The periodicity of the twist is referred to as its “pitch” (“p”). The orientation or order of the liquid crystal host may be changed upon application of an electric field, and in combination with the dyestuff material, may be used to control or partially control the optical properties of the optical filter. In some embodiments, the CLC may be further characterized by its chirality, i.e., right-handed chirality or left-handed chirality.

### Order Parameter and Dichroic Ratio

The maximum contrast between the clear and dark states of an active LC cell depends on the alignment of the dichroic dyes. Dichroic dyes have the ability to align themselves with nematic liquid crystal molecules when mixed together. When an electric field is applied to such a guest-host mixture, the nematic liquid crystal host molecules reorient and align either with or perpendicular to the electric field in order to minimize the torque they experience from the electric field. The dichroic dye (guest) molecules may not be directly affected by the external electric field but can align themselves with the liquid crystal host molecules. It is their interaction with the liquid crystal molecules that forces them to reorient.

The statistically averaged orientation of the elongated molecules, liquid crystal and dichroic dye, in a guest-host mixture points in a particular direction that is called the “director.” Since all molecules in the mixture are subject to random thermal motion as they diffuse, each molecule will not point in exactly the same direction as the director, even when an electric field is applied. A statistical average of the molecular orientation reveals that the molecules are tilted at an average angle θ_{avg} with respect to the director. This molecular tilt can also be characterized and calculated by a useful quantity called the “order parameter, S”, which ranges in value from 0 to 1. An order parameter of S=1 corresponds to all molecules being perfectly aligned with the director (θ_{avg}=0°). (See Liquid Crystals Applications and Uses, vol. 3, edited by B. Bahadur, published by World Scientific Publishing Co. Pte. Ltd., 1992). Thus, the higher the order parameter S, the more the dichroic dye molecules are aligned, thereby optimizing absorption for any particular molecular orientation. The present invention includes a dichroic dye liquid crystal guest-host mixture with an effective order parameter Sₘᵢₓ which is greater than or equal to 0.78, 0.79 or 0.8.

As used herein, the “guest-host mixture order parameter value” or “Sₘᵢₓ” refers to the order parameter of the guest-host mixture. The mixture may contain one or more dyes as well as other dopants. The Sₘᵢₓ can be measured according to the method described herein, e.g. using the formula for S_{eff} or S_{eff-agg}. Thus, as used herein Sₘᵢₓ, S_{eff} and S_{eff-agg} are used interchangeably (depending on which method is used to measure the order parameter) and describe the same parameter. The “dye order parameter value” or “S_{dye}” refers to the order parameter of the transition dipole of each dichroic dye with respect to the director.

In one example, the effective order parameter of guest host mixture containing one or more dichroic dyes may be calculated as S_{eff}=(D_{eff}−1)/(D_{eff}+2), where D_{eff}=(∫A_{∥}(λ)dλ)/(∫A_{⊥}(λ)dλ) is the “effective dichroic ratio” and A_{∥}(λ) and A_{⊥}(λ) are the parallel and perpendicular absorbance of the dye and D(λ) is the corresponding dichroic ratio at wavelength λ. Typically, ∫A_{∥}(λ)dλ and ∫A_{⊥}(λ)d∥ are evaluated over the wavelength region of absorption which is typically within the 380-780 nm region of the spectrum. For the present invention, these integrals can be evaluated at a specific wavelength, over the FWHM of the absorption spectrum of the wide band dichroic dye mixture, or over a band such as 400-700 nm region of the spectrum. If the absorption spectrum has a single peak, the integrals are simple to evaluate, the integration limits being the wavelengths of the end-points of the FWHM of the spectrum. If there is more than one distinct peak in the absorption spectrum, the integrals are evaluated in a piece-wise fashion, the integration limits being the wavelengths of the end-points of the FWHM of each peak. This piece-wise integration produces what the Applicant calls an “aggregate dichroic ratio” D_{eff-agg} and an “aggregate effective order parameter” S_{eff-agg}.

The order parameter of the mixture can be determined by optical measurements of the light transmission in the resting and energized states using linearly and/or circularly polarized lights at several wavelengths both within and outside of the absorption spectrum. Then, using liquid crystal optics simulation methods such as those developed by Berreman, (Berreman D. W. 1972, Optics in Stratified and Anisotropic Media: 4×4-Matrix Formulation. Journal of the Optical Society of America, 62(4), 502). or Odano (Allia, P., Oldano, G., & Trossi, L., 1986, 4×4 Matrix approach to chiral liquid-crystal optics. Journal of the Optical Society of America B, 3(3), 424); the order parameter can be determined by numerical fitting to the experimental data. These simulation methods are used by those skilled in the art or through commercial programs such as Twisted Cell Optics by Kelly (Kelly, J., Jamal, S., & Cui, M., 1999, Simulation of the dynamics of twisted nematic devices including flow. Journal of Applied Physics, 86(8), 4091).

For the purposes of this invention, an order parameter of 1 also indicates that all the molecules are aligned with each other. For example, all the dichroic dye molecules are aligned with each other, presenting near identical absorption cross-sections to the incident light and maximizing absorption for that particular orientation. Of course, it must be kept in mind that perfect alignment is difficult to achieve since the molecules are always subject to thermal motion. To maximize optical performance, a guest-host mixture is desired wherein the inter-molecular alignment is increased because of the application of an external field.

In some examples, a desirable guest-host mixture will have an order parameter value Sₘᵢₓ of greater than 0.78. In other examples, the Sₘᵢₓ is equal to or greater than 0.79. In yet other examples, the Sₘᵢₓ is equal to or greater than 0.8. Mixtures with Sₘᵢₓ>0.78 are needed that provide a wide transmission swing (30-70%, preferably >35%) across the A-FWHM.

In some examples, if more than one dye is used, to minimize color variation in the resting (de-energized) and energized states, it is desirable that all dyes have approximately the same order parameter.

“Dichroic ratio”, “average dichroic ratio” or Dₘᵢₓ of the mixture, similarly, refers to the dichroic ratio of the guest-host mixture over a region of spectrum which may contain one or more dichroic dyes. As explained above, the dichroic ratio may be measured using the formula for D_{eff} or D_{eff-agg}. Thus, as used herein, D(λ), Dₘᵢₓ, D_{eff} or D_{eff-agg} are used interchangeably (depending on which method is used to measure the dichroic ratio) and describe the same parameter.

### Dyestuff Material

To provide dichroic properties, the dyestuff material generally includes at least one dichroic (DC) dye or mixture of DC dyes (DC light-absorbing moieties). In some cases, the dyestuff material may optionally further include a photochromic (PC) dye or a photochromic-dichroic (PCDC) dye whose light absorbance may be activated by exposure to UV light such as sunlight. In some embodiments, the dyestuff material may further include a small amount of a conventional absorbing dye, e.g., to provide the device with a desired overall hue in the clear state. In some embodiments, the dyestuff material includes substantially only DC dyes.

### DC Dyes

Dichroic dyes typically have an elongated molecular shape and exhibit anisotropic absorption. Commonly, the absorption is higher along the long axis of the molecule and such dyes may be referred to as “positive dyes” or dyes exhibiting positive dichroism. Positive DC dyes are generally used herein. However, in some cases, negative DC dyes that exhibit negative dichroism may be used instead. In some embodiments, a DC dye (as measured in a CLC host) may have a dichroic ratio of at least 5.0, alternatively at least 6, 7, 8, 9, 10, 11, 12, 13, 14, 15, 16, 17, 18, 19 or 20. In some cases, the dichroic ratio of the DC dye (as measured in a CLC host) may be in a range of 5-6, 6-8, 8-10, 10-15, 15-20, 20-25, 25-30, or any combination of ranges thereof.

The level of visible light absorption by the DC dye may be a function of the dye type and the CLC host. For active optical filters of the present disclosure, the apparent absorption of visible light may also be a function of voltage. The orientation or long-range order of the CLC may be a function of electric field or voltage across the cell thickness. A DC dye exhibits some alignment with the CLC host so that application of a voltage may be used to alter the apparent darkness of the cell.

In some embodiments, a DC dye may include a small molecule type of material (organic, inorganic, organometallic, organic complexes of a metal, or the like). In some embodiments, a DC dye may include an oligomeric or polymeric material. The chemical moiety responsible for light absorption may, for example, be a pendent group on a main chain. Multiple DC dyes may optionally be used, for example, to tune the light absorption envelope or to improve overall cell performance with respect to lifetime or some other property. DC dyes may include functional groups that may improve solubility, miscibility with or bonding to the CLC host. Some non-limiting examples of DC dyes may include azo dyes, for example, azo dyes having 2 to 10 azo groups, or alternatively, 2 to 6 azo groups. Other DC dyes are known in the art, such as anthraquinone and perylene dyes. Generally, any molecule with dichroic properties can be used.

In some embodiments, a guest-host mixture has a nematic-isotropic transition temperature TNI greater than 40° C. In other embodiments, the TNI is greater than 45° C., 50° C., 55° C., 60° C., 65° C., 70° C., 75° C., 80° C., 85° C. or 90° C.

In some embodiments, the optical filter includes a guest-host mixture with an order parameter, Sₘᵢₓ, greater than or equal to 0.60, 0.65, 0.7, 0.71, 0.72, 0.73, 0.74, 0.75, 0.76, 0.77 or 0.78, 0.79, 0.80, 0.81, 0.82, 0.83, 0.84, or 0.85.

In some embodiments, an optical filter of the present disclosure having reduced vignetting at wide viewing angles may use a guest-host mixture that may be described as “chiral planar”.

### Other Cell Features

### Substrate

Referring again to FIG. 4, in some embodiments, the substrate 12a, 12b, may be independently selected and may include a plastic, a glass, a ceramic, or some other material. Choice of material and its particular properties depends in part on the intended application. The substrate should be at least partially transmissive to visible light. In some embodiments a substrate may have higher than 45% transmission to visible radiation having a wavelength between 400 nm and 700 nm, alternatively, higher than 50%, 60%, 70%, 80%, 90%, or 95% transmission. In some embodiments, the substrate may have high optical clarity so that a person or sensor may clearly see through the optical filter 10. In some embodiments, the substrate may optionally have some color or tint. In some embodiments, the substrate may have an optical coating on the outside of the cell. A substrate may be flexible or rigid.

As some non-limiting examples, a plastic substrate may include a polycarbonate (PC), a polycarbonate and copolymer blend, a polyethersulfone (PES), a polyethylene terephthalate (PET), cellulose triacetate (TAC), a polyamide, p-nitrophenylbutyrate (PNB), a polyetheretherketone (PEEK), a polyethylenenapthalate (PEN), a polyetherimide (PEI), polyarylate (PAR), a polyvinyl acetate, a cyclic olefin polymer (COP) or other similar plastics known in the art. In some non-limiting examples, flexible glass including materials such as Corning® Willow® Glass and the like can be used as a substrate. A substrate may include a multiple materials or have a multi-layer structure. In some embodiments, an optical filter may use plastic substrates that have an optical retardation with less than ±20% variation in uniformity across the area of the device, alternatively less than ±15%, or less than ±10%.

In some embodiments, the thickness of a substrate may be in a range of 10-20 μm, 20-30 μm, 30-40 μm, 40-50 μm, 50-75 μm, 75-100 μm, 100-150 μm, 150-200 μm, 200-250 μm, 250-300 μm, 300-350 μm, 350-400 μm, 400-450 μm, 450-500 μm, 500-600 μm, 600-800 μm, 800-1000 μm, or greater than 1 mm or any combination of ranges thereof.

### Transparent Conducting Layer

By “transparent” conducting layer, it is meant that the conducting layer 14a, 14b allows at least 45% of incident visible light to pass through. A transparent conducting layer may absorb or reflect a portion of visible light and still be useful. In some embodiments, the transparent conducting layer may include a transparent conducting oxide (TCO) including, but not limited to, ITO or AZO. In some embodiments, the transparent conducting layer may include a conductive polymer including, but not limited to, PEDOT:PSS, a poly(pyrrole), a polyaniline, a polyphenylene, or a poly(acetylene). In some embodiments, the transparent conducting layer may include a partially transparent thin layer of metal or metal nanowires, e.g., formed of silver, copper, aluminum, or gold. In some embodiments, the transparent conducting layer may include graphene.

### Optical Filter System Properties

As mentioned, many variable transmission optical filters have been designed to keep maximize swing in the transmission. One approach is to minimize the polarization dependence. Furthermore, ideally, the eigenmodes of propagation remain independent of the propagation angle. This can be best achieved, for example, with low birefringence. For optical filters having reduced vignetting, however, it has been discovered that the system should be redesigned. In some cases, an angular dependence in the eigenmodes of propagation can be used to counteract the additional losses seen in an isotropic material as predicted by Beers law. For example, the reduced vignetting optical filters may use materials having higher birefringence and operate closer to the Mauguin limit.

As is known in the art, a birefringent material has a refractive index that is dependent upon the polarization of light. In some cases, a birefringent material may be characterized by its Δn. This value can be positive or negative, but unless otherwise noted, Δn as discussed herein refers to its absolute value. In some embodiments, an LC host may have |Δn| of at least 0.04, alternatively, at least 0.05, 0.06, 0.07, 0.08, 0.09, or 0.1. In some cases, an LC host may have |Δn| of no more than 0.3, alternatively, no more than 0.2. In some embodiments, an LC host may have |Δn| in a range of 0.04-0.06, 0.06-0.08, 0.08-0.10, 0.10-0.15, 0.15-0.20, 0.20-0.25, 0.25-0.30, or any combination of ranges thereof. In some embodiments, the LC host may be characterized by positive anisotropy.

In some embodiments, the LC-GH material layer pitch, p, may be at least as large as the wavelength(s) of light that the DC moiety is absorbing. In some embodiments, p is at least 300 nm, alternatively at least 400 nm, 500 nm, 750 nm, 1 μm, 2 μm, 3 μm, 4 μm, 5 μm, or 10 μm. In some embodiments p is in a range of 400-500 nm, 500-750 nm, 750 nm-1 μm, 1-2 μm, 2-3 μm, 3-4 μm, 4-5 μm, 5-10 μm, 10-15 μm, 15-20 μm, 20-25 μm, 25-30 μm, or any combination of ranges thereof.

In some embodiments, the optical filter cell gap or thickness of the LC-GH material layer may be in a range of 3 to 5 μm, 5 to 7 μm, 7 to 10 μm, 10 to 15 μm, or 15 to 20 μm, 20-25 μm, 25-30 μm, 30-40 μm, 40-50 μm, 50-70 μm, 70-100 μm, or any combination of ranges thereof, or even higher than 100 μm.

In some embodiments, the optical filter may be characterized by a d/p ratio. Recall that “d” refers to the thickness of the LC-GH material layer and p is the pitch of the twisting LC host. For embodiments where low vignetting is desired, the d/p ratio may be at least 0.1, alternatively at least 0.25, 0.5, 1, 2, 3, 4, 5, 6, 7, 8, 9, or 10. In some embodiments, the d/p ratio is in a range of 0.1-0.5, alternatively 0.5-1, 1-2, 2-3,3-4,4-5,5-6,6-7, 7-8, 8-9, 9-10, 10-15, 15-20, or any combination of ranges thereof.

In some embodiments, an optical filter having reduced vignetting may use an LC host having positive anisotropy having lAnM in a range of 0.04-0.20, have p in a range of 0.8-4 microns, a d/p ratio in a range of 0.25-4, and an order parameter of 0.6-0.9.

In some cases, the physical and optical properties of the optical filter may be characterized by a vignetting optical metric (OM), as described by equation (1):

$$OM = log [ ( D ( λ ) - 1 ) * ( \vert Δ n \vert * p ) / λ ] \qquad ( 1 )$$

wherein OM=the vignetting optical metric, D(λ)=the dichroic ratio of the light absorbing moiety at the wavelength λ, |Δn|=the birefringence of the liquid crystal host, p=the pitch of the liquid crystal host (μm), and λ=the wavelength of light absorbed by the light absorbing moiety (μm). OM may be in a range of −1.3 to 3.0, or alternatively in a range of 0.0 to 2.5, 0.3 to 2.0, or 0.5 to 1.5.

In some embodiments, the average clear state transmission of an active optical filter in a wavelength range of 400 nm-700 nm may be equal to or above 35%, 40%, 45%, 50%, 55%, 60%, 65%, 70%, 75%, 80%, 85%, 90%, 95%, 96%, 97%, 98% or 99%. In some embodiments, the average darkened state transmission of an active optical filter in a wavelength range of 400 nm-700 nm may be equal to or below 55%, 50%, 45%, 40%, 35%, 30%, 25%, 20%, 15%, 10%, 5% or 1%. In some embodiments, an active optical filter may have a transmission swing (the difference between the most transmissive “clear” state and the least transmissive “dark” state) that is greater than or equal to 30%, alternatively greater than 35%, 40%, 45%, 50%, 55%, 60%, 65%, 70%, 75%, or 80%. The aforementioned transmission levels may in some cases apply to the entire wavelength range of 400 nm-700 nm, but may alternatively apply to just a single wavelength within this range or to a subset of wavelengths within this range. In some cases, any of the aforementioned transmission levels may correspond to a wavelength range of 400-420 nm, 420-440 nm, 440-460 nm, 460-480 nm, 480-500 nm, 500-520 nm, 520-540 nm, 540-560 nm, 560-580 nm, 580-600 nm, 600-620 nm, 620-640 nm, 640-660 nm, 660-680 nm, or 680-700 nm, or any combination of ranges thereof.

In some embodiments, an optical filter of the present disclosure (active or passive) may have a absorbance of at least 0.05 for normal incident light (θ₁=0°), alternatively at least, 0.1, 0.2, 0.3, 0.4, 0.5, 0.7, 1.0, 1.5, 2.0, 2.5, or 3.0. In some embodiments, the optical filter may have an absorbance at normal incidence of in a range of 0.05-0.2, 0.2-0.3, 0.3-0.4, 0.4-0.5, 0.5-0.7, 0.7-1.0, 1.0-1.5, 1.5-2.0, 2.0-2.5, 2.5-3.0, or any combination of ranges thereof. Such absorbance levels are with respect to the wavelength or wavelength range of interest.

For some embodiments, optical filters of the present disclosure may be characterized by an absorbance (or % T) that deviates from an absorbance (or % T) predicted by Beer's law for light incident at an angle θ₁ from normal, where θ₁ is greater than 0°, for example, greater than 10°, 20°, 30°, 40°, 50°, or 60°. Note that “predicted by Beer's law” refers to the predicted absorbance after also applying Snell's law to account for pathlength through the filter and reflection losses at the air/filter interface, based on an average index of refraction of the filter and angle of incidence. In some embodiments this deviation is observed when θ₁ is in a range of 10° to 20°, alternatively 20° to 30°, 30° to 40°, 40° to 50°, 50° to 60°, 60° to 70°, or any combination of ranges thereof. In some embodiments, a test for such deviation from Beer's law may be made at any angle in the above ranges, for example, at 20°, 30°, 40°, 45°, 50°, or 60°. In some embodiments, the filter may have, or be able to produce, an absorbance of at least 0.1, alternatively at least 0.2, 0.5, 1.0, or 2.0 for normal incident light (θ₁=0°). In some embodiments, the filter may have, or be able to produce, a % T of less than about 80%, alternatively less than about 70%, 60%, 50%, 20%, 10%, 5%, or 1% for normal incident light (θ₁=0°).

For reduced vignetting optical filters, the absorbance may be less than predicted by Beer's law at θ₁>0°. For example, an absorbance measured at one or more of the aforementioned θ₁ angles or ranges may be less than 0.99 times the absorbance predicted by Beer's law (“absorbance deviation factor”), alternatively less than 0.98, 0.97, 0.95, 0.93, 0.90, 0.85, 0.80, 0.75, 0.70, 0.65, or 0.60 times the absorbance predicted by Beer's law. In some embodiments, higher θ₁ may produce a lower absorbance deviation factor for reduced vignetting optical filters.

Similarly, for reduced vignetting optical filters, the % T may be higher than predicted by Beer's law. For example, a % T measured at one or more of the aforementioned θ₁ angles or ranges may be greater than 1.01 times the % T predicted by Beer's law (“% T deviation factor”), alternatively, greater than 1.02, 1.05, 1.1, 1.2, 1.3, 1.4, 1.5, 1.7, 2.0, 2.5, or 3 times the % T predicted by Beer's law.

As mentioned, some optical filters of the present disclosure may be designed for increased vignetting (or that may be variable between increased and reduced). For increased vignetting optical filters, the absorbance may be higher than predicted by Beer's law at θ₁>0°. For example, an absorbance measured at one or more of the aforementioned θ₁ angles or ranges may be greater than 1.01 times the absorbance predicted by Beer's law (“absorbance deviation factor”), alternatively greater than 1.02, 1.03, 1.05, 1.07, 1.10, 1.15, 1.20, 1.25, 1.30, 1.35, or 1.40 times the absorbance predicted by Beer's law. In some embodiments, higher θ₁ may produce a higher absorbance deviation factor for increased vignetting optical filters.

Similarly, for increased vignetting optical filters, the % T may be higher than predicted by Beer's law. For example, a % T measured at one or more of the aforementioned θ₁ angles or ranges may be less than 0.99 times the % T predicted by Beer's law (“% T deviation factor”), alternatively, less than 0.98, 0.95, 0.90, 0.8, 0.7, 0.6, 0.5, 0.3, or 0.1 times the % T predicted by Beer's law.

A variable vignetting filter (typically an active filter) is one that can produce different levels of vignetting, e.g., as measured within a range of 30° to 70°, but maintain the same absorbance or % T measured normal to the filter. In some embodiments, a variable vignetting filter may be able to alternate between reduced vignetting and increased vignetting.

In some embodiments an optical filter of the present disclosure may characterized by an absorbance A_{θ} for light measured at incident angle θ₁ from normal to the filter surface, that is at least 1% higher or at least 1% lower than a theoretical absorbance A_{T} predicted by Beer's law when θ is in a range of 30° to 70° and the filter has an absorbance (A_{N}) of at least 0.1 measured normal to the filter, alternatively at least 0.5 or at least 1.0. In some cases, A_{θ} may be outside a range of 0.99A_{T} to 1.01A_{T}, alternatively outside a range of 0.98A_{T} to 1.02A_{T}. 0.95A_{T} to 1.05A_{T}, 0.93A_{T} to 1.07A_{T}, or 0.90A_{T} to 1.10A_{T}. In some embodiments, variable vignetting filters may be designed to further operate within the noted ranges in addition to operating outside (above and/or below) them. In the case of a reduced vignetting optical filter, A_{θ} may be greater than 1.01A_{T}, alternatively greater than 1.02A_{T}, 1.05A_{T}, 1.07A_{T}, or 1.10A_{T}. In the case of an increased vignetting filter, A_{θ} may be less than 0.99A_{T}, alternatively less than 0.98A_{T}, 0.95A_{T}, 0.93A_{T}, or 0.90A_{T}.

In some embodiments, the optical filter may be characterized by a vignetting factor VF corresponding to the ratio of the absorbance of incident light normal to the filter (A_{N}) to the absorbance an angle θ from normal (A_{θ}). That is, VF=A_{N}/A_{θ}. In some embodiments, optical filters of the present disclosure may have, or be capable of producing, a VF outside a range of 0.89-0.93, alternatively 0.88-0.94, or alternatively 0.87-0.95, when measured at θ=40° (i.e., V₄₀) and the filter has an absorbance (A_{N}) of at least 0.1 measured normal to the filter, alternatively at least 0.5 or at least 1.0. In some embodiments, variable vignetting filters may be designed to further operate within the noted ranges in addition to operating outside (above and/or below) them. In the case of a reduced vignetting optical filter (also measured at θ=40°), VF may be greater than 0.93, alternatively greater than 0.94, or alternatively greater than 0.95. In some embodiments a reduced vignetting optical filter may have a VF of 1.0 or less. In some cases, an optical filter may even have VF exceeding 1.0 which may also be described as inverted vignetting. In the case of an increased vignetting optical filter (also measured at θ=40°), VF may be less than 0.89, alternatively less than 0.88, or alternatively less than 0.87. VF may in some cases be function of incident angle. For example, when measured at θ=60° and the filter has an absorbance (A_{N}) of at least 0.1 measured normal to the filter, alternatively at least 0.5 or at least 1.0, optical filters of the present disclosure may have, or be capable of producing, a VF outside a range of 0.79-0.84, 0.78-0.85, 0.77-0.86, 0.75-0.88, or 0.73-0.90. In some embodiments, variable vignetting filters may be designed to further operate within the noted ranges in addition to operating outside (above and/or below) them. In the case of a reduced vignetting optical filter (also measured at θ=60°), VF may be greater than 0.84, alternatively greater than 0.85, 0.86, 0.88, or 0.90. In the case of an increased vignetting optical filter (also measured at θ=60°), VF may be less than 0.79, alternatively less than 0.78, 0.77, 0.75, or 0.73.

### Applications

In some embodiments, the reduced vignetting optical filters of the present disclosure (passive or active, but passive in particular) may be used in camera systems. In some cases, such camera systems may employ wide-angle lens and the present filter may be referred to as a wide-angle optical filter. Such camera systems may use digital imaging sensors (CMOS, CCD or the like) or alternatively use silver halide film. Useful camera systems may include still image cameras, video cameras, or cinematography cameras,

In some embodiments, reduced vignetting active optical filters of the present disclosure are particularly suitable for sunroofs in vehicles or in other window applications where uniform darkening is important, and may in some cases be as important or more important than clear state performance.

In some embodiments, a variable vignetting active optical filter may be used create desired edge darkening effects for camera systems, sunroofs, windows, or eyewear.

Still further embodiments herein include the following enumerated embodiments.
1. A light absorbing filter disposed in association with an optical element and a light source, the filter including a chiral anisotropic liquid crystal host and a dichroic light absorbing moiety in association with the host, wherein the filter is characterized by an absorbance A_{θ} for light measured at incident angle θ from normal to the filter surface, that is at least 1% higher or at least 1% lower than an absorbance A_{T} predicted by Beer's law when θ is at least 30°.
2. The light absorbing filter of embodiment 1, wherein A_{θ} is outside a range of 0.99A_{T} to 1.01A_{T} for at least one incident angle θ in a range of 30°-70°.
3. The light absorbing filter of embodiment 2, wherein A_{θ} is outside a range of 0.98A_{T} to 1.02A_{T}, or optionally outside a range of 0.95A_{T} to 1.05A_{T}, 0.93A_{T} to 1.07A_{T}, or 0.90A_{T} to 1.10A_{T}.
4. The light absorbing filter according to any of embodiments 1-3, wherein θ is about 40°, or about 60°.
5. The light absorbing filter according to any of embodiments 1-4, wherein the filter is a reduced vignetting filter having A_{θ} greater than 1.01A_{T}, or optionally having A_{θ} greater than 1.02A_{T}, 1.05A_{T}, 1.07A_{T}, or 1.10A_{T}.
6. The light absorbing filter according to any of embodiments 1-4, wherein the filter is an increased vignetting filter having A_{θ} less than 0.99A_{T}, or optionally less than 0.98A_{T}, 0.95A_{T}, 0.93A_{T}, or 0.90A_{T}.
7. The light absorbing filter according to any of embodiments 1-6, wherein the filter is a passive filter.
8. The light absorbing filter according to any of embodiments 1-7, wherein the filter is an active filter.
9. The light absorbing filter according to any of embodiments 1-4, wherein the filter is an active variable vignetting filter.
10. The light absorbing filter according to any of embodiments 1-9, wherein for light incident normal to the filter, the filter has an absorbance of at least 0.1, or optionally an absorbance of at least 0.2, 0.5, or 1.0.
11. A light absorbing filter disposed in association with an optical element and a light source, the filter including a chiral anisotropic liquid crystal host and a dichroic light absorbing moiety in association with the host,
wherein:
a) VF_{θ}=A_{N}/A_{θ}, wherein i) VF_{θ} is the filter vignetting factor for light incident at an angle θ from normal, ii) A_{N} is the absorbance of incident light normal to the filter, and iii) A_{θ} is the absorbance of light incident an angle θ;
b) A_{N} is at least 0.1; and
c) when θ=40°, VF₄₀ is outside a range of 0.89-0.93
12. The light absorbing filter of embodiment 11, wherein VF₄₀ is outside a range of 0.88-0.94, or optionally 0.87-0.95.
13. The light absorbing filter of embodiment 11 or 12, wherein when θ=60°, VF₆₀ is outside a range of 0.79-0.84, or optionally 0.78-0.85, 0.77-0.86, 0.75-0.88, or 0.73-0.90.
14. The light absorbing filter according to any of embodiments 11-13, wherein A_{N} is at least 0.2, or optionally at least 0.5, or 1.0.
15. The light absorbing filter according to any of embodiments 11-14, wherein the filter is a reduced vignetting filter having VF₄₀ greater than 0.93, or optionally greater than 0.94 or 0.95.
16. The light absorbing filter according to any of embodiments 11-14, wherein the filter is an increased vignetting filter having VF₄₀ less than 0.89, or optionally less than 0.88 or
0.87.
17. The light absorbing filter according to any of embodiments 11-16, wherein the filter is a passive filter.
18. The light absorbing filter according to any of embodiments 11-17, wherein the filter is an active filter.
19. The light absorbing filter according to any of embodiments 11-14, wherein the filter is an active variable vignetting filter.
20. The light absorbing filter according to any of embodiments 1-19, wherein the optical element is a lens.
21. The light absorbing filter of embodiment 20, wherein the lens is a wide-angle lens.
22. The light absorbing filter according to any of embodiments 1-19, wherein the optical element is a sensor of an imaging device.
23. The light absorbing filter according to any of embodiments 1-22, wherein the light source corresponds to an ambient environment for image capture by a camera.
24. The light absorbing filter according to any of embodiments 1-19, wherein the optical element includes a sunroof or window.
25. The light absorbing filter according to any of embodiments 1-24, wherein the light absorbing moiety includes one or more dichroic dyes.
26. The light absorbing filter of embodiment 25, wherein the one or more dichroic dyes are combined with the liquid crystal host as a mixture.
27. The light absorbing filter of embodiment 25 or 26, wherein at least one dichroic dye is covalently bonded to the liquid crystal host.
28. The light absorbing filter according to any of embodiments 25-27, wherein the liquid crystal host is polymeric.
29. The light absorbing filter according to any of embodiments 1-28, wherein the light absorbing moiety has a dichroic ratio of at least 5.
30. The light absorbing filter according to any of embodiments 1-29, wherein the anisotropic liquid crystal host and the dichroic light absorbing moiety are provided between two substrates.
31. The light absorbing filter according to any of embodiments 1-29, wherein the filter is in the form of a free-standing polymeric film including the anisotropic liquid crystal host and the dichroic light absorbing moiety.
32. The light absorbing filter according to any of embodiments 1-31, wherein the filter is a neutral density filter having an absorbance of at least 0.5.
33. The light absorbing filter according to any of embodiments 1-32, wherein the filter is a color filter having an absorbance of at least 0.5 with respect to at least one wavelength in a range of 400 nm to 700 nm.
34. The light absorbing filter according to any of embodiments 1-33, wherein the filter is substantially planar.
35. The light absorbing filter according to any of embodiments 1-33, wherein the filter includes a multicurved surface.
36. The light absorbing filter according to any of embodiments 1-35, wherein the filter is laminated onto the optical element.
37. The light absorbing filter according to any of embodiments 1-36, wherein the liquid crystal host has a positive anisotropy.
38. The light absorbing filter according to any of embodiments 1-37, wherein the liquid crystal host has a birefringence |Δn| of at least 0.04, or optionally in a range of 0.04 to 0.30, or optionally in a range of 0.06 to 0.20, or optionally in a range of 0.06 to 0.17.
39. The light absorbing filter according to any of embodiments 1-38, wherein the light absorbing moiety has dichroic ratio D is in a range of 5 to 30, or optionally in a range of 8 to 20.
40. The light absorbing filter according to any of embodiments 1-39, wherein the liquid crystal host is characterized by a pitch p in a range of 0.3 to 30 μm, or optionally in a range of 1 to 15 μm, or optionally in a range of 4 to 12 μm.
41. The light absorbing filter according to any of embodiments 1-40, wherein the filter is further characterized by equation (1):

$$OM = log [ ( D ( λ ) - 1 ) * ( \vert Δ n \vert * p ) / λ ] \qquad ( 1 )$$

wherein:
   OM=the vignetting optical metric, wherein OM is in a range of −1.3 to 3.0
   D(λ)=the dichroic ratio of the light absorbing moiety at the wavelength λ;
         |Δn|=the birefringence of the liquid crystal host;
   p=the pitch of the liquid crystal host (μm); and
   λ=the wavelength of light absorbed by the light absorbing moiety (μm).
42. The light absorbing filter of embodiment 41, wherein OM is in a range of 0.3 to 2.0, or optionally in a range of 0.5 to 1.5.
43. A method of capturing an image having reduced vignetting, the method including attaching a filter to a camera lens assembly, wherein the filter is the light absorbing filter according to any of embodiments 1-42 or 49-74.
44. The method of embodiment 44, wherein the light absorbing filter is a passive filter.
45. The method of embodiment 43 or 44, wherein the light absorbing moiety has a dichroic ratio of at least 5.
46. The method according to any of embodiments 43-45, wherein the filter is a neutral density filter having an absorbance of at least 0.5.
47. The method according to any of embodiments 43-45, wherein the filter is a color filter having an absorbance of at least 0.5 with respect to at least one wavelength in a range of 400 nm to 700 nm.
48. The method according to any of embodiments 43-47, wherein the camera lens assembly includes a wide-angle lens.
49. A light absorbing filter disposed in association with an optical element and a light source, the filter including a chiral anisotropic liquid crystal host and a dichroic light absorbing moiety in association with the host, wherein the filter is characterized by equation (1):

$$OM = log [ ( D ( λ ) - 1 ) * ( \vert Δ n \vert * p ) / λ ] \qquad ( 1 )$$

wherein:
   OM=the vignetting optical metric, wherein OM is in a range of −1.3 to 3.0
   D(λ)=the dichroic ratio of the light absorbing moiety at the wavelength λ;
         |Δn|=the birefringence of the liquid crystal host;
   p=the pitch of the liquid crystal host (μm); and
   λ=the wavelength of light absorbed by the light absorbing moiety (μm).
50. The light absorbing filter of embodiment 49, wherein OM is in a range of 0.3 to 2.0, or alternatively 0.5 to 1.5.
51. The light absorbing filter of embodiment 49 or 50, wherein |Δn| is in a range of 0.06 to 0.20.
52. The light absorbing filter according to any of embodiments 49-51, wherein D in a range of 5 to 30, or alternatively 8 to 20.
53. The light absorbing filter according to any of embodiments 49-52, wherein p is in a range of 0.3-30 μm, or alternatively 1-15 μm.
54. The light absorbing filter according to any of embodiments 49-53, wherein for light incident normal to the filter, the filter has an absorbance at λ of at least 0.5.
55. The light absorbing filter according to any of embodiments 49-54, wherein the filter is a passive filter.
56. The light absorbing filter according to any of embodiments 49-54, wherein the filter is an active filter.
57. The light absorbing filter according to any of embodiments 49-54, wherein the filter is an active variable-vignetting filter.
58. The light absorbing filter according to any of embodiments 49-57, wherein the optical element is a lens.
59. The light absorbing filter of embodiment 58, wherein the lens is a wide-angle lens.
60. The light absorbing filter according to any of embodiments 49-57, wherein the optical element is a sensor of an imaging device.
61. The light absorbing filter according to any of embodiments 49-60, wherein the light source corresponds to an ambient environment for image capture by a camera.
62. The light absorbing filter according to any of embodiments 49-57 wherein the optical element includes a sunroof or window.
63. The light absorbing filter according to any of embodiments 49-62, wherein the light absorbing moiety includes one or more dichroic dyes.
64. The light absorbing filter of embodiment 63, wherein the one or more dichroic dyes are combined with the liquid crystal host as a mixture.
65. The light absorbing filter of embodiment 63 or 64, wherein at least one dichroic dye is covalently bonded to the liquid crystal host.
66. The light absorbing filter according to any of embodiments 63-65, wherein the liquid crystal host is polymeric.
67. The light absorbing filter according to any of embodiments 49-66, wherein the light absorbing moiety has a dichroic ratio of at least 10.
68. The light absorbing filter according to any of embodiments 49-67, wherein the anisotropic liquid crystal host and the dichroic light absorbing moiety are provided between two substrates.
69. The light absorbing filter according to any of embodiments 49-67, wherein the filter is in the form of a free-standing polymeric film including the anisotropic liquid crystal host and the dichroic light absorbing moiety.
70. The light absorbing filter according to any of embodiments 49-69, wherein the filter is a neutral density filter having an absorbance of at least 0.5.
71. The light absorbing filter according to any of embodiments 49-69, wherein the filter is a color filter having an absorbance of at least 0.5 with respect to at least one wavelength in a range of 400 nm to 700 nm.
72. The light absorbing filter according to any of embodiments 49-71, wherein the filter is substantially planar.
73. The light absorbing filter according to any of embodiments 49-71, wherein the filter includes a multicurved surface.
74. The light absorbing filter according to any of embodiments 49-73, wherein the filter is laminated onto the optical element.
75. The light absorbing filter according to any of embodiments 49-74, wherein the liquid crystal host has a positive anisotropy.
76. The light absorbing filter according to any of embodiments 49-74, wherein the liquid crystal host has a negative anisotropy.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, the upper and lower limits are included in the range. Further, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the layer” includes reference to one or more layers and equivalents thereof known to those skilled in the art, and so forth. The invention has now been described in detail for the purposes of clarity and understanding. However, it will be appreciated that certain changes and modifications may be practiced within the scope of the appended claims.

All publications, patents, and patent applications cited herein are hereby incorporated by reference in their entirety for all purposes. None is admitted to be prior art.

1. A light absorbing filter disposed in association with an optical element and a light source, the filter comprising a chiral anisotropic liquid crystal host having positive anisotropy and a dichroic light absorbing moiety in association with the host, wherein the filter is characterized by an absorbance A_{θ} for light measured at incident angle θ from normal to the filter surface, that is at least 1% higher or at least 1% lower than an absorbance A_{T} predicted by Beer's law when θ is at least 30°.

2. The light absorbing filter of claim 1, wherein the liquid crystal host has a birefringence |Δn| in a range of 0.06 to 0.20.

3. The light absorbing filter of claim 1, wherein the light absorbing moiety has a dichroic ratio D of at least 5.

4. The light absorbing filter of claim 3, wherein D is in a range of 8 to 20.

5. The light absorbing filter of claim 1, wherein the liquid crystal host has a pitch in a range of 1-15 μm.

6. The light absorbing filter of claim 1, wherein the filter is further characterized by equation (1):
$$OM = log [ ( D ( λ ) - 1 ) * ( \vert Δ n \vert * p ) / λ ] \qquad ( 1 )$$
wherein:
OM=a vignetting optical metric, wherein OM is in a range of −1.3 to 3.0
D(λ)=a dichroic ratio of the light absorbing moiety at wavelength λ;

|Δn|=a birefringence of the liquid crystal host;
p=a pitch of the liquid crystal host (μm); and
λ=a wavelength of light absorbed by the light absorbing moiety (μm).

7. The light absorbing filter of claim 6, wherein OM is in a range of 0.3 to 2.0.

8. The light absorbing filter of claim 1, wherein A_{θ} is outside a range of 0.99A_{T} to 1.01A_{T} for at least one incident angle θ in a range of 30°-70°.

9. The light absorbing filter of claim 1, wherein the filter is a reduced vignetting filter having A_{θ} greater than 1.02A_{T}.

10. The light absorbing filter of claim 1, wherein the filter is a passive filter or an active variable-vignetting filter.

11. The light absorbing filter of claim 1, wherein for light incident normal to the filter, the filter has an absorbance of at least 0.1.

12-21. (canceled)

22. The light absorbing filter of claim 1, wherein the anisotropic liquid crystal host and the dichroic light absorbing moiety are provided between two substrates.

23. The light absorbing filter of claim 1, wherein the filter is in the form of a free-standing polymeric film including the anisotropic liquid crystal host and the dichroic light absorbing moiety.

24. The light absorbing filter of claim 1, wherein the filter is a neutral density filter having an absorbance of at least 0.5.

25. The light absorbing filter of claim 1, wherein the filter is a color filter having an absorbance of at least 0.5 with respect to at least one wavelength in a range of 400 nm to 700 nm.

26. The light absorbing filter of claim 1, wherein filter is substantially planar, or wherein filter includes a multicurved surface.

27. The light absorbing filter of claim 1, wherein the optical element is a lens.

28. The light absorbing filter of claim 1, wherein the optical element is a sensor of an imaging device.

29. The light absorbing filter of claim 1, wherein the optical element is a sunroof or a window.

30. The light absorbing filter of claim 1, wherein the filter is laminated onto the optical element.
